(19) United States
(12) Patent Application Publication
(10) Pub. No.: US 2024/0424444 A1
(43) Pub. Date: Dec. 26, 2024

(54) PARTICULATE FILTER HAVING A CENTRALIZED-DISTRIBUTED PGM AND PROCESS FOR PREPARING THE SAME

(71) Applicant: BASF Corporation, Florham Park, NJ (US)

(72) Inventors: Jun Cong Jiang, Beijing (CN); Yipeng Sun, Iselin, NJ (US); Aleksei Vjunov, Iselin, NJ (US); Ye Hui Wu, Shanghai (CN); Attilio Siani, Hannover (DE)

(21) Appl. No.: 18/274,002

(22) PCT Filed: Jan. 25, 2022
(86) PCT No.: PCT/US2022/013631

§ 371 Date: Jul. 25, 2023

(30) Foreign Application Priority Data
Jan. 27, 2021 (WO) PCT/CN2021/073980

(51) Int. Cl. B01D 53/94; B01J 23/46; B01J 23/63; B01J 35/00; B01J 35/56; B01J 37/02; B01J 37/08; F01N 3/035

(52) U.S. Cl. CPC B01D 53/945; B01J 23/464; B01J 23/63; B01J 35/19; B01J 35/56; B01J 37/0236; B01J 37/0242; B01J 37/08; F01N 3/035; B01D 2255/1023; B01D 2255/1025; B01D 2255/2042; B01D 2255/20715; B01D 2255/2092; B01D 2255/407; B01D 2255/905; B01D 2255/9155; B01D 2258/01; F01N 2510/068

(57) ABSTRACT

The disclosure relates to a particulate filter for the treatment of exhaust gas from an internal combustion engine, wherein the particulate filter comprises a catalyst material layer comprising at least one platinum group metal, and the average loading of platinum group metal in the region which is around the whole central axis of the particulate filter and accounts for 20 to 70 vol. % of the total volume of the particulate filter, is 1.1 to 10 times the average loading of platinum group metal in the remaining part of the particulate filter. The particulate filter according to the present invention has a centralized-distributed PGM in the radial direction, shows excellent HC, NOx, and CO conversions and low backpressure.

### CROSS-REFERENCE TO RELATED APPLICATIONS

This application claims the benefit of priority to International Application No. PCT/CN2021/073980, filed Jan. 27, 2021 in its entirety.

### TECHNOLOGY FIELD

The present invention relates to a particulate filter for the treatment of exhaust gas from an internal combustion engine, wherein the particulate filter has a centralized-distributed platinum group metal in radial direction, relates to a process for preparing the particulate filter and relates to a method for the treatment of exhaust gas from an internal combustion engine.

### BACKGROUND

The exhaust gas from internal combustion engine contains in relatively large part of nitrogen, water vapor, and carbon dioxide; but the exhaust gas also contains in relatively small part of noxious and/or toxic substances, such as carbon monoxide from incomplete combustion, hydrocarbons from un-burnt fuel, nitrogen oxides (NOx) from excessive combustion temperatures, and particulate matter (PM).

On Dec. 23, 2016, the Ministry of Environmental Protection (MEP) of the People's Republic of China published the final legislation for the China 6 limits and measurement methods for emissions from light-duty vehicles (GB18352.6-2016; hereafter referred to as China 6), which is much stricter than the China 5 emission standard. Especially, China 6b incorporates limits on particulate matter (PM) and adopts the on-board diagnostic (OBD) requirements. Furthermore, it is implemented that vehicles should be tested under World Harmonized Light-duty Vehicle Test Cycle (WLTC). WLTC includes many steep accelerations and prolonged highspeed requirements, which demand high power output that could have caused “open-loop” situation (as fuel paddle needs to be pushed all the way down) at extended time (e.g., >5 sec) under rich (lambda <1) or under deep rich (lambda <0.8) conditions.

As particulate standards become more stringent, however, there is a need to provide particulate trapping functionality without unduly crowding the exhaust pipe and increasing backpressure. Moreover, HC, NOx, and CO conversions continue to be of interest. In order to reduce the emissions of carbon monoxide, hydrocarbons and nitrogen oxides, one possible way is increasing the loading of platinum group metal by using a higher washcoat loading, which increases the pressure drop across the filter.

Since the public and government are seriously concerned about hydrocarbon, NOx, carbon monoxide and particulate emission from mobile sources, there is a continuing need to provide a particulate filter that provides excellent HC, NOx, and CO conversions without unduly increasing backpressure.

### SUMMARY OF THE INVENTION

It is an object of the present invention to provide a particulate filter having a centralized-distributed platinum group metal in the radial direction, which shows excellent HC, NOx, and CO conversions and low backpressure.

Another object of the present invention is to provide a process for preparing the particulate filter for the treatment of exhaust gas from an internal combustion engine.

A further object of the present invention is to provide a method for the treatment of exhaust gas from an internal combustion engine, which comprises flowing the exhaust gas from the engine through the particulate filter according to the present invention.

It has been surprisingly found that the above objects can be achieved by following embodiments:

1. A particulate filter for the treatment of exhaust gas from an internal combustion engine, wherein the particulate filter comprises a catalyst material layer comprising at least one platinum group metal, and the average loading of platinum group metal in the region which is around the whole central axis of the particulate filter and accounts for 20 to 70 vol. % of the total volume of the particulate filter, is 1.1 to 10 times the average loading of platinum group metal in the remaining part of the particulate filter.

2. The particulate filter according to item 1, wherein the average loading of platinum group metal in said region around the whole central axis and accounting for 20 to 70 vol. % of the total volume of the particulate filter, is 1.2 to 8 times, preferably 1.25 to 6 times the average loading of platinum group metal in the remaining part of the particulate filter.

3. The particulate filter according to item 1 or 2, wherein the difference in the average loading of the catalyst material layer between said region around the whole central axis and accounting for 20 to 70 vol. % of the total volume of the particulate filter and the remaining part of the particulate filter is no more than 25%, preferably no more than 15%, more preferably no more than 5%, based on the lower average loading of the catalyst material layer.

4. The particulate filter according to any of items 1 to 3, wherein said region around the whole central axis and accounting for 20 to 70 vol. % of the total volume of the particulate filter is evenly divided into three subregions along the whole central axis, i.e., inlet subregion, intermediate subregion and outlet subregion, wherein the average loading of platinum group metal in one or two subregions, preferably in the inlet and outlet subregions is 1.5 to 15 times, preferably 1.8 to 10 times, more preferably 2 to 7 times the average loading of platinum group metal in the remaining subregion(s).

5. The particulate filter according to any of items 1 to 4, wherein the particulate filter comprises a catalyst material layer comprising at least one platinum group metal, and the amount of the platinum group metal in the region which is around the whole central axis of the particulate filter and accounts for 11.1 vol. % of the total volume of the particulate filter, is in the range from 12 to 35 wt. %, based on the total weight of the platinum group metal in the particulate filter, and
wherein the difference in the average loading of the catalyst material layer between said region accounting for 11.1 vol. % of the total volume of the particulate filter and the remaining part of the particulate filter is no more than 25%, based on the lower average loading of the catalyst material layer.

6. The particulate filter according to item 5, wherein the amount of the platinum group metal in the region which is around the whole central axis of the particulate filter and accounts for 11.1 vol. % of the total volume of the particulate filter, is in the range from 12.5 to 30 wt. %, preferably from 13 to 28 wt. %, in particular from 13 to 25 wt. %, based on the total weight of the platinum group metal in the particulate filter.

7. The particulate filter according to item 5 or 6, wherein the difference in the average loading of the catalyst material layer between said region accounting for 11.1 vol. % of the total volume of the particulate filter and the remaining part of the particulate filter is no more than 15%, preferably no more than 5%, based on the lower average loading of the catalyst material layer.

8. The particulate filter according to any of items 1 to 7, wherein the amount of the platinum group metal in the region which is around the whole central axis of the particulate filter and accounts for 25 vol. % of the total volume of the particulate filter, is in the range from 27 to 60 wt. %, preferably from 28 to 55 wt. %, more preferably from 29 to 50 wt. %, based on the total weight of the platinum group metal in the particulate filter, and
wherein the difference in the average loading of the catalyst material layer between said region accounting for 25 vol. % of the total volume of the particulate filter and the remaining part of the particulate filter is no more than 25%, preferably no more than 15%, more preferably no more than 5%, based on the lower average loading of the catalyst material layer.

9. The particulate filter according to any of items 1 to 8, wherein the amount of the platinum group metal in the region which is around the whole central axis of the particulate filter and accounts for 32.3 vol. % of the total volume of the particulate filter, is in the range from 34 to 80 wt. %, preferably from 36 to 75 wt. %, more preferably from 37 to 70 wt. %, based on the total weight of the platinum group metal in the particulate filter, and
wherein the difference in the average loading of the catalyst material layer between said region accounting for 32.3 vol. % of the total volume of the particulate filter and the remaining part of the particulate filter is no more than 25%, preferably no more than 15%, more preferably no more than 5%, based on the lower average loading of the catalyst material layer.

10. The particulate filter according to any of items 1 to 9, wherein the amount of the platinum group metal in the region which is around the whole central axis of the particulate filter and accounts for 44.4 vol. % of the total volume of the particulate filter, is in the range from 47 to 85 wt. %, preferably from 49 to 80 wt. %, more preferably from 50 to 78 wt. %, based on the total weight of the platinum group metal in the particulate filter, and
wherein the difference in the average loading of the catalyst material layer between said region accounting for 44.4 vol. % of the total volume of the particulate filter and the remaining part of the particulate filter is no more than 25%, preferably no more than 15%, more preferably no more than 5%, based on the lower average loading of the catalyst material layer.

11. The particulate filter according to any of items 5 to 10, wherein said region accounting for 11.1 vol. % of the total volume of the particulate filter is evenly divided into three subregions along the whole central axis, i.e., inlet subregion, intermediate subregion and outlet subregion, wherein the average loading of platinum group metal in one or two subregions, preferably in the inlet and outlet subregions is 1.5 to 15 times, preferably 1.8 to 10 times, more preferably 2 to 7 times the average loading of platinum group metal in the remaining subregion(s).

12. The particulate filter according to item 9, wherein said region accounting for 32.3 vol. % of the total volume of the particulate filter is evenly divided into three subregions along the whole central axis, i.e., inlet subregion, intermediate subregion and outlet subregion, and wherein the average loading of platinum group metal in one or two subregions, preferably in the inlet and outlet subregions is 1.5 to 15 times, preferably 1.8 to 10 times, more preferably 2 to 7 times the average loading of platinum group metal in the remaining subregion(s).

13. The particulate filter according to any of items 1 to 12, wherein the average loading of the platinum group metal of the particulate filter is in the range from 2 to 50 g/ft³, preferably from 3 to 25 g/ft³, more preferably from 4 to 20 g/ft³.

14. The particulate filter according to any of items 1 to 13, wherein the average loading of the catalyst material layer of the particulate filter is in the range from 0.2 to 3 g/in³, preferably from 0.3 to 2.5 g/in³, more preferably from 0.5 to 2 g/in³.

15. The particulate filter according to any of items 1 to 14, wherein the catalyst material layer further comprises at least one refractory metal oxide.

16. A process for preparing the particulate filter according to any of items 1 to 15, which comprises
i) providing a filter substrate;
ii) coating the filter substrate with a slurry containing at least one platinum group metal; and
iii) further coating the filter substrate obtained in step ii) with a solution or dispersion containing at least one platinum group metal.

17. The process according to item 16, wherein the slurry comprises at least one refractory metal oxide.

18. The process according to item 16 or 17, wherein the amount of platinum group metal applied in step iii) is 50 to 120% by weight, preferably 60 to 100% by weight of the amount of platinum group metal applied in step ii).

19. The process according to any of items 16 to 18, wherein step ii) and step iii) further comprise calcinating the coated filter substrate after coating.

20. A method for the treatment of exhaust gas from an internal combustion engine, which comprises flowing the exhaust gas from the engine through the particulate filter according to any one of items 1 to 15.

21. The method according to item 20, wherein the exhaust gas comprises unburned hydrocarbons, carbon monoxide, nitrogen oxides, and particulate matter.

The particulate filter according to the present invention has a centralized-distributed platinum group metal in the radial direction, which shows excellent HC, NOx, and CO conversions and low backpressure. In addition, the process according to the present invention allows to produce the particulate filter according to the present invention in a very simple and efficient way.

### DESCRIPTION OF THE DRAWING

FIG. 1 shows a plot of gas emission results of catalytic particulate filters, tested as close-coupled catalyst (CCC), according to the present invention (examples 2, 3 and 4) and a prior art particulate filter (Example 1—Comparative), tested under WLTC.

FIG. 2 shows a plot of gas emission results of catalytic particulate filters, tested as close-coupled catalyst, according to the present invention (examples 2, 3 and 4) and a prior art particulate filter (Example 1—Comparative), tested under WLTC phase 1.

FIG. 3 shows a plot of gas emission results of catalytic particulate filters, tested in a CCC+UFC system as underfloor catalyst (UFC), according to the present invention (examples 2, 3 and 4) and a prior art particulate filter (Example 1—Comparative), tested under WLTC.

FIG. 4 shows a plot of gas emission results of catalytic particulate filters, tested as close-coupled catalyst, according to the present invention (Examples 2 and 5) and a prior art particulate filter (Examples 1 and 6—comparative), tested under WLTC.

FIG. 5 shows a plot of gas emission results of catalytic particulate filters, tested as close-coupled catalyst, according to the present invention (Examples 2 and 5) and a prior art particulate filter (Examples 1 and 6—comparative), tested under WLTC phase 1.

FIG. 6 shows backpressure add-on values of catalytic particulate filters tested at 600 m³/h flow rate and 25° C. (Example 2—present invention, Examples 1 and 7—comparative).

FIG. 7 shows PGM distribution layout for Examples 1 to 7.

FIG. 8 (a) and FIG. 8 (b) show an exemplary wall-flow filter.

### EMBODIMENT OF THE INVENTION

The following abbreviations have been used:
“HC”=hydrocarbon;
“NOx”=nitrogen oxides;
“CO”=carbon monoxide;
“WLTC”=World Harmonized Light-duty Vehicle Test Cycle;
“PM”=particulate matter;
“CCC”=close-coupled catalyst;
“UFC”=underfloor catalyst;
“OSC”=oxygen storage component;
“PGM”=platinum group metal;
“WFF”=wall flow filter;
“SCR catalyst”=selective catalytic reduction catalyst;
“DOC”=diesel oxidation catalyst;
“DEC”=Diesel Exotherm catalyst;
“TWC catalyst”=Three-way conversion catalyst.

The undefined article “a”, “an”, “the” means one or more of the species designated by the term following said article.

In the context of the present disclosure, any specific values mentioned for a feature (comprising the specific values mentioned in a range as the end point) can be recombined to form a new range.

In the context of the present disclosure, each aspect so defined may be combined with any other aspect or aspects unless clearly indicated to the contrary. In particular, any feature indicated as being preferred or advantageous may be combined with any other feature or features indicated as being preferred or advantageous.

As used herein, the term “catalyst” or “catalyst composition” refers to a material that promotes a reaction.

As used herein, the terms “upstream” and “downstream” refer to relative directions according to the flow of an engine exhaust gas stream from an engine towards a tailpipe, with the engine in an upstream location and the tailpipe and any pollution abatement articles such as filters being downstream from the engine.

The terms “exhaust gas”, “exhaust stream,” “engine exhaust stream, “exhaust gas stream” and the like refer to any combination of flowing engine effluent gas that may also contain solid or liquid particulate matter. The stream comprises gaseous components and is, for example, exhaust of a lean burn engine, which may contain certain non-gaseous components such as liquid droplets, solid particulates and the like. An exhaust stream of a lean burn engine typically further comprises combustion products, hydrocarbon, products of incomplete combustion, oxides of nitrogen, combustible and/or carbonaceous particulate matter (soot) and un-reacted oxygen and/or nitrogen.

As used herein, the term “washcoat” has its usual meaning in the art of a thin, adherent coating of a catalytic or other material applied to a substrate material.

A washcoat is formed by preparing a slurry containing a certain solid content (e.g., 30-90% by weight) of particles in a liquid medium, which is then coated onto a substrate and dried to provide a washcoat layer.

The catalyst may be “fresh” meaning it is new and has not been exposed to any heat or thermal stress for a prolonged period of time. “Fresh” may also mean that the catalyst was recently prepared and has not been exposed to any exhaust gases. Likewise, an “aged” catalyst is not new and has been exposed to exhaust gases and elevated temperature (i.e., greater than 500° C.) for a prolonged period of time (i.e., greater than 3 hours).

A “support” in a catalytic material or catalyst washcoat refers to a material that receives metals (e.g., PGMs), stabilizers, promoters, binders, and the like through precipitation, association, dispersion, impregnation, or other suitable methods. Exemplary supports include refractory metal oxide supports as described herein below.

“Refractory metal oxide supports” are metal oxides including, for example, alumina, silica, titania, ceria, and zirconia, magnesia, barium oxide, manganese oxide, tungsten oxide, and rear earth metal oxide rear earth metal oxide, base metal oxides, as well as physical mixtures, chemical combinations and/or atomically-doped combinations there-of and including high surface area or activated compounds such as activated alumina. Exemplary combinations of metal oxides include alumina-zirconia, alumina-ceria-zirconia, lanthana-alumina, lanthanazirconia-alumina, baria-alumina, baria-lanthana-alumina, baria-lanthana-neodymia alumina, and alumina-ceria. Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina, and low bulk density large pore boehmite and gamma-alumina. Such materials are generally considered as providing durability to the resulting catalyst.

“High surface area refractory metal oxide supports” refer specifically to support particles having pores larger than 20 Å and a wide pore distribution. High surface area refractory metal oxide supports, e.g., alumina support materials, also referred to as “gamma alumina” or “activated alumina,” typically exhibit a BET surface area of fresh material in excess of 60 square meters per gram (“m2/g”), often up to about 200 m2/g or higher. Such activated alumina is usually a mixture of the gamma and delta phases of alumina, but may also contain substantial amounts of eta, kappa and theta alumina phases.

The term “NOx” refers to nitrogen oxide compounds, such as NO or NO₂.

As used herein, the term “oxygen storage component” (OSC) refers to an entity that has a multi-valence state and can actively react with reductants such as carbon monoxide (CO) and/or hydrogen under reduction conditions and then react with oxidants such as oxygen or nitrogen oxides under oxidative conditions. Examples of oxygen storage components include rare earth oxides, particularly ceria, lanthana, praseodymia, neodymia, niobia, europia, samaria, ytterbia, yttria, zirconia, and mixtures thereof.

A platinum group metal (PGM) component refers to any component that includes a PGM (Ru, Rh, Os, Ir, Pd, Pt and/or Au). For example, the PGM may be in metallic form, with zero valence, or the PGM may be in an oxide form. Reference to “PGM component” allows for the presence of the PGM in any valence state. The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide.

One aspect of the present invention is directed to a particulate filter for the treatment of exhaust gas from an internal combustion engine, wherein the particulate filter comprises a catalyst material layer comprising at least one platinum group metal, and the average loading of platinum group metal in the region which is around the whole central axis of the particulate filter and accounts for 20 to 70 vol. % of the total volume of the particulate filter, is 1.1 to 10 times the average loading of platinum group metal in the remaining part of the particulate filter.

In the context of the present invention, “the region which is around the whole central axis” means said region shares the same central axis with the filter”. A person skilled in the art can understand that said region is the central region of the particulate filter. Taking a particulate filter in the form of cylinder (1) with a radius of R and a length of L as an example, the expression “the region which is around the whole central axis of the particulate filter and accounts for 20 vol. % of the total volume of the particulate filter” means a small cylinder sharing the same central axis with the cylinder (1) and having a radius of 0.45 R and a length of L; the expression “the region which is around the whole central axis of the particulate filter and accounts for 70 vol. % of the total volume of the particulate filter” means a small cylinder sharing the same central axis with the cylinder (1) and having a radius of 0.84 R and a length of L.

According to the present invention, the “average loading of PGM” in a region can be calculated as follows: average loading of PGM in a region=amount of PGM in said region/volume of said region. For example, if the volume of a region around the whole central axis of the particulate filter and accounting for 20 vol. % of the total volume of the particulate filter is m (f³) and the amount of PGM in said region is n (g), the average loading of PGM in said region=n/m (g/ft³).

The amount of platinum group metal can be determined through elemental analysis. For example, firstly, the radial distribution of the platinum group metal can be determined through elemental analysis on defined sample area. Then, the amount of platinum group metal in the region can be determined according to the radial distribution of the platinum group metal.

For example, cores within defined radius of the filter can be taken from the filter. Then, the sample can be analyzed on a Malvern Panalytical Axios FAST wavelength-dispersive X-ray fluorescence (XRF) spectrometer.

The particulate filter is typically formed of a porous substrate. The porous substrate may comprise a ceramic material such as, for example, cordierite, silicon carbide, silicon nitride, zirconia, mullite, spodumene, alumina-silica-magnesia, zirconium silicate, and/or aluminium titanate, typically cordierite or silicon carbide. The porous substrate may be a porous substrate of the type typically used in emission treatment systems of internal combustion engines.

The internal combustion engine may be a lean-burn engine, a diesel engine, a natural gas engine, a power plant, an incinerator, or a gasoline engine.

The porous substrate may exhibit a conventional honey-comb structure. The filter may take the form of a conventional “through-flow filter”. Alternatively, the filter may take the form of a conventional “wall flow filter” (WFF). Such filters are known in the art.

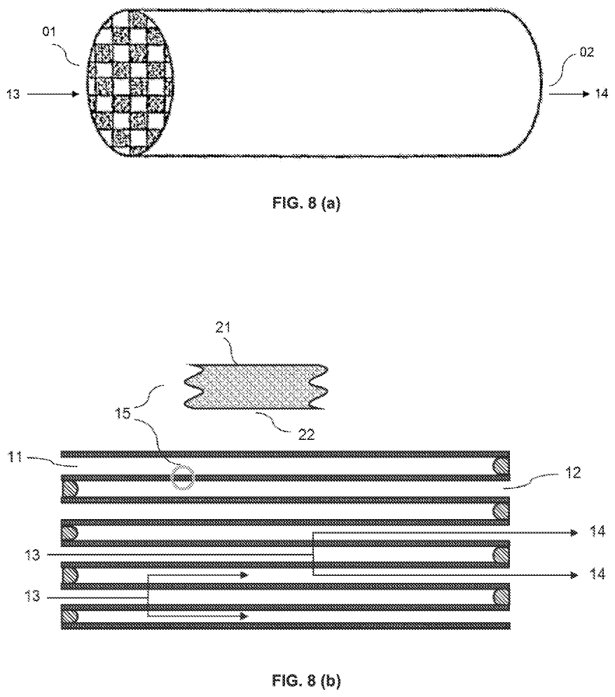

The particulate filter is preferably a wall-flow filter. Referring to FIG. 8 (a) and FIG. 8 (b), an exemplary wall-flow filter is provided. Wall-flow filters work by forcing a flow of exhaust gases (13) (including particulate matter) to pass through walls formed of a porous material.

A wall flow filter typically has a first face and a second face defining a longitudinal direction therebetween. In use, one of the first face and the second face will be the inlet face for exhaust gases (13) and the other will be the outlet face for the treated exhaust gases (14). A conventional wall flow filter has first and second pluralities of channels extending in the longitudinal direction. The first plurality of channels (11) is open at the inlet face (01) and closed at the outlet face (02). The second plurality of channels (12) is open at the outlet face (02) and closed at the inlet face (01). The channels are preferably parallel to each other to provide a constant wall thickness between the channels. As a result, gases entering one of the plurality of channels from the inlet face cannot leave the monolith without diffusing through the channel walls (15) from the inlet side (21) to the outlet side (22) into the other plurality of channels. The channels are closed with the introduction of a sealant material into the open end of a channel. Preferably the number of channels in the first plurality is equal to the number of channels in the second plurality, and each plurality is evenly distributed throughout the monolith. Preferably, within a plane orthogonal to the longitudinal direction, the wall flow filter has from 100 to 500 channels per square inch, preferably from 200 to 400. For example, on the inlet face (01), the density of open channels and closed channels is from 200 to 400 channels per square inch. The channels can have cross sections that are rectangular, square, circular, oval, triangular, hexagonal, or other polygonal shapes.

In a preferred embodiment, the average loading of platinum group metal in said region around the whole central axis and accounting for 20 to 70 vol. % of the total volume of the particulate filter, is 1.2 to 8 times, for example 1.25, 1.3, 1.35, 1.4, 1.5, 1.8, 2.0, 2.5, 3, 3.5, 4, 5, 6, 7 or 8 times, preferably 1.25 to 6 times the average loading of platinum group metal in the remaining part of the particulate filter.

In a preferred embodiment, the catalyst material layer of the particulate filter is substantially uniform. According to the present invention, the substantially uniform catalyst material layer having centralized-distributed platinum group metal in the radial direction can shows excellent HC, NOx, and CO conversions and lower backpressure. For the substantially uniform catalyst material layer, the difference in the average loading of the catalyst material layer between said region around the whole central axis and accounting for 20 to 70 vol. % of the total volume of the particulate filter and the remaining part of the particulate filter can be no more than 25%, based on the lower average loading of the catalyst material layer. For example, if the average loading of the catalyst material layer in a region around the whole central axis and accounting for 20% of the total volume of the particulate filter (average loading_{20 vol. %}) is higher than the average loading of the catalyst material layer in the remaining part of the particulate filter (average loading_{80 vol. %}), then the difference can be calculated as follows: (average loading_{20%}−average loading_{80 vol. %})×100%/average loading_{80 vol. %}.

In a preferred embodiment, the difference in the average loading of the catalyst material layer between said region accounting for 20 to 70 vol. % of the total volume of the particulate filter and the remaining part of the particulate filter can be no more than 20%, no more than 15% or no more than 10%, preferably no more than 5% or no more than 2%, in particularly no more than 1%, based on the lower average loading of the catalyst material layer.

In a preferred embodiment, said region around the whole central axis and accounting for 20 to 70 vol. % of the total volume of the particulate filter is evenly divided into three subregions along the whole central axis, i.e., inlet subregion, intermediate subregion and outlet subregion, wherein the average loading of platinum group metal in one or two subregions, preferably in the inlet and outlet subregions is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the remaining subregion(s).

Examples of said region around the whole central axis and accounting for 20 to 70 vol. % of the total volume of the particulate filter can include a region around the whole central axis and accounting for 22 to 70 vol. % of the total volume of the particulate filter, a region around the whole central axis and accounting for 25 to 70 vol. % of the total volume of the particulate filter, a region around the whole central axis and accounting for 30 to 70 vol. % of the total volume of the particulate filter, for example 35 vol. %, 40 vol. %, 45 vol. %, 50 vol. %, 55 vol. %, 60 vol. %, 65 vol. %, 68 vol. % or 69 vol. % of the total volume of the particulate filter. A person skilled in the art could understand that any description for said region around the whole central axis and accounting for 20 to 70 vol. % of the total volume of the particulate filter in the context of this disclosure can apply to these exemplary regions.

One aspect of the present invention is directed to a particulate filter for the treatment of exhaust gas from an internal combustion engine, wherein the particulate filter comprises a catalyst material layer comprising at least one platinum group metal, and the amount of the platinum group metal in the region which is around the whole central axis of the particulate filter and accounts for 11.1 vol. % of the total volume of the particulate filter, is in the range from 12 to 35 wt. %, based on the total weight of the platinum group metal in the particulate filter, and wherein the difference in the average loading of the catalyst material layer between said region accounting for 11.1 vol. % of the total volume of the particulate filter and the remaining part of the particulate filter is no more than 25%, based on the lower average loading of the catalyst material layer.

According to the present invention, the particulate filter comprises a catalyst material layer comprising at least one platinum group metal, and the amount of the platinum group metal in the region which is around the whole central axis of the particulate filter and accounts for 11.1 vol. % of the total volume of the particulate filter, is in the range from 12 to 35 wt. %, for example 12 wt. %, 12.2 wt. %, 12.5 wt. %, 12.8 wt. %, 13 wt. %, 13.5 wt. %, 14 wt. %, 15 wt. %, 18 wt. %, 20 wt. %, 25 wt. %, 30 wt. %, or 35 wt. %, preferably from 12.5 to 30 wt. %, more preferably from 13 to 28 wt. %, in particular from 13 to 25 wt. %, based on the total weight of the platinum group metal in the particulate filter. As mentioned above, any specific values mentioned for a feature (comprising the specific values mentioned in a range as the end point) can be recombined to form a new range, for example new ranges 13 to 35 wt. % or 18 to 25 wt. % can be mentioned here.

In the context of the present invention, “the region which is around the whole central axis” means said region shares the same central axis with the filter”. A person skilled in the art can understand that said region is the central region of the particulate filter. Taking a particulate filter in the form of cylinder (1) with a radius of R and a length of L as an example, the expression “the region which is around the whole central axis of the particulate filter and accounts for 11.1 vol. % of the total volume of the particulate filter” means a small cylinder sharing the same central axis with the cylinder (1) and having a radius of ⅓ R and a length of L. For the particulate filter in the cube (1) with a side-length of A, the expression “the region which is around the whole central axis of the particulate filter and accounts for 11.1 vol. % of the total volume of the particulate filter” means a small cuboid sharing the same central axis with the cube (1), wherein both the length and width of the cuboid is ⅓ A and the height of the cuboid is A.

According to the present invention, the particulate filter of the present invention has a substantially uniform catalyst material layer. The difference in the average loading of the catalyst material layer between said region accounting for 11.1 vol. % of the total volume of the particulate filter and the remaining part of the particulate filter is no more than 25%, based on the lower average loading of the catalyst material layer. In this regard, if the average loading of the catalyst material layer in said region accounting for 11.1 vol. % of the total volume of the particulate filter (average loading_{11.1. vol %}) is higher than the average loading of the catalyst material layer in the remaining part of the particulate filter (average loading_{88.9 vol. %}) then the difference can be calculated as follows: (average loading_{11.1 vol %}−average loading_{88.9 vol %})×100%/average loading_{88.9 vol %}.

The difference in the average loading of the catalyst material layer between said region accounting for 11.1 vol. % of the total volume of the particulate filter and the remaining part of the particulate filter can be no more than 20%, no more than 15% or no more than 10%, preferably no more than 5% or no more than 2%, in particularly no more than 1%, based on the lower average loading of the catalyst material layer.

In an preferred embodiment, said region accounting for 11.1 vol. % of the total volume of the particulate filter is evenly divided into three subregions along the whole central axis, i.e., inlet subregion, intermediate subregion and outlet subregion, wherein the average loading of platinum group metal in one or two subregions, for example in the inlet subregion, or in the intermediate subregion, or in the outlet subregion, or in the inlet and intermediate subregions, or in the intermediate and outlet subregions, or in the inlet and outlet subregions, preferably in the inlet and outlet subregions is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the remaining subregion(s).

According to a preferred embodiment, the amount of the platinum group metal in the region which is around the whole central axis of the particulate filter and accounts for 25 vol. % of the total volume of the particulate filter, is in the range from 27 to 60 wt. %, for example 28 wt. %, 29 wt. %, 30 wt. %, 31 wt. %, 32 wt. %, 33 wt. %, 34 wt. %, 35 wt. %, 38 wt. %, 40 wt. %, 45 wt. %, 50 wt. %, 55 wt. %, or 60 wt. %, preferably from 28 to 55 wt. %, more preferably from 29 to 50 wt. %, based on the total weight of the platinum group metal in the particulate filter, and wherein the difference in the average loading of the catalyst material layer between said region accounting for 25 vol. % of the total volume of the particulate filter and the remaining part of the particulate filter is no more than 25%.

In a preferred embodiment, the difference in the average loading of the catalyst material layer between said region accounting for 25 vol. % of the total volume of the particulate filter and the remaining part of the particulate filter can be no more than 20%, no more than 15% or no more than 10%, preferably no more than 5% or no more than 2%, in particularly no more than 1%, based on the lower average loading of the catalyst material layer.

In an preferred embodiment, said region accounting for 25 vol. % of the total volume of the particulate filter is evenly divided into three subregions along the whole central axis, i.e., inlet subregion, intermediate subregion and outlet subregion, wherein the average loading of platinum group metal in one or two subregions, for example in the inlet subregion, or in the intermediate subregion, or in the outlet subregion, or in the inlet and intermediate subregions, or in the intermediate and outlet subregions, or in the inlet and outlet subregions, preferably in the inlet and outlet subregions is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the remaining subregion(s).

In a preferred embodiment, the amount of the platinum group metal in the region which is around the whole central axis of the particulate filter and accounts for 32.3 vol. % of the total volume of the particulate filter, is in the range from 34 to 80 wt. %, for example 35 wt. %, 36 wt. %, 37 wt. %, 38 wt. %, 39 wt. %, 40 wt. %, 41 wt. %, 42 wt. %, 45 wt. %, 50 wt. %, 55 wt. %, 60 wt. %, preferably from 36 to 75 wt. %, more preferably from 37 to 70 wt. % or 38 to 68 wt. %, based on the total weight of the platinum group metal in the particulate filter, and
wherein the difference in the average loading of the catalyst material layer between said region accounting for 32.3 vol. % of the total volume of the particulate filter and the remaining part of the particulate filter is no more than 25%.

In a preferred embodiment, the difference in the average loading of the catalyst material layer between said region accounting for 32.3 vol. % of the total volume of the particulate filter and the remaining part of the particulate filter can be no more than 20%, no more than 15% or no more than 10%, preferably no more than 5% or no more than 2%, in particularly no more than 1%, based on the lower average loading of the catalyst material layer.

In an preferred embodiment, said region accounting for 32.3 vol. % of the total volume of the particulate filter is evenly divided into three subregions along the whole central axis, i.e., inlet subregion, intermediate subregion and outlet subregion, wherein the average loading of platinum group metal in one or two subregions, for example in the inlet subregion, or in the intermediate subregion, or in the outlet subregion, or in the inlet and intermediate subregions, or in the intermediate and outlet subregions, or in the inlet and outlet subregions, preferably in the inlet and outlet subregions is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the remaining subregion(s).

In a preferred embodiment, the amount of the platinum group metal in the region which is around the whole central axis of the particulate filter and accounts for 44.4 vol. % of the total volume of the particulate filter, is in the range from 47 to 85 wt. %, for example 48 wt. %, 49 wt. %, 50 wt. %, 51 wt. %, 52 wt. %, 53 wt. %, 54 wt. %, 55 wt. %, 56 wt. %, 57 wt. %, 58 wt. %, 60 wt. %, 65 wt. %, 70 wt. %, 75 wt. %, or 80 wt. %, preferably from 49 to 80 wt. %, more preferably from 50 to 78 wt. % or from 51 to 75 wt. %, based on the total weight of the platinum group metal in the particulate filter, and
wherein the difference in the average loading of the catalyst material layer between said region accounting for 44.4 vol. % of the total volume of the particulate filter and the remaining part of the particulate filter is no more than 25%.

In a preferred embodiment, the difference in the average loading of the catalyst material layer between said region accounting for 44.4 vol. % of the total volume of the particulate filter and the remaining part of the particulate filter can be no more than 20%, no more than 15% or no more than 10%, preferably no more than 5% or no more than 2%, in particularly no more than 1%, based on the lower average loading of the catalyst material layer.

In a preferred embodiment, said region accounting for 44.4 vol. % of the total volume of the particulate filter is evenly divided into three subregions along the whole central axis, i.e., inlet subregion, intermediate subregion and outlet subregion, wherein the average loading of platinum group metal in one or two subregions, for example in the inlet subregion, or in the intermediate subregion, or in the outlet subregion, or in the inlet and intermediate subregions, or in the intermediate and outlet subregions, or in the inlet and outlet subregions, preferably in the inlet and outlet subregions is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the remaining subregion(s).

In a preferred embodiment, the amount of the platinum group metal in the region which is around the whole central axis of the particulate filter and accounts for 56.3 vol. % of the total volume of the particulate filter, is in the range from 60 to 90 wt. %, for example 61 wt. %, 62 wt. %, 63 wt. %, 64 wt. %, 65 wt. %, 66 wt. %, 67 wt. %, 68 wt. %, 69 wt. %, 70 wt. %, 72 wt. %, 75 wt. %, 80 wt. %, 82 wt. %, 85 wt. %, or 88 wt. %, preferably from 62 to 85 wt. %, more preferably from 64 to 80 wt. %, based on the total weight of the platinum group metal in the particulate filter, and
wherein the difference in the average loading of the catalyst material layer between said region accounting for 56.3 vol. % of the total volume of the particulate filter and the remaining part of the particulate filter is no more than 25%.

In a preferred embodiment, the difference in the average loading of the catalyst material layer between said region accounting for 56.3 vol. % of the total volume of the particulate filter and the remaining part of the particulate filter can be no more than 20%, no more than 15% or no more than 10%, preferably no more than 5% or no more than 2%, in particularly no more than 1%, based on the lower average loading of the catalyst material layer.

In an preferred embodiment, said region accounting for 56.3 vol. % of the total volume of the particulate filter is evenly divided into three subregions along the whole central axis, i.e., inlet subregion, intermediate subregion and outlet subregion, wherein the average loading of platinum group metal in one or two subregions, for example in the inlet subregion, or in the intermediate subregion, or in the outlet subregion, or in the inlet and intermediate subregions, or in the intermediate and outlet subregions, or in the inlet and outlet subregions, preferably in the inlet and outlet subregions is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the remaining subregion(s).

In a preferred embodiment, the amount of the platinum group metal in the region which is around the whole central axis of the particulate filter and accounts for 69.4 vol. % of the total volume of the particulate filter, is in the range from 75 to 95 wt. %, for example 78 wt. %, 80 wt. %, 82 wt. %, 85 wt. %, 88 wt. %, 90 wt. % or 92 wt. %, preferably from 78 to 90 wt. %, more preferably from 80 to 88 wt. %, based on the total weight of the platinum group metal in the particulate filter, and
wherein the difference in the average loading of the catalyst material layer between said region accounting for 69.4 vol. % of the total volume of the particulate filter and the remaining part of the particulate filter is no more than 25%.

In a preferred embodiment, the difference in the average loading of the catalyst material layer between said region accounting for 69.4 vol. % of the total volume of the particulate filter and the remaining part of the particulate filter can be no more than 20%, no more than 15% or no more than 10%, preferably no more than 5% or no more than 2%, in particularly no more than 1%, based on the lower average loading of the catalyst material layer.

In an preferred embodiment, said region accounting for 69.4 vol. % of the total volume of the particulate filter is evenly divided into three subregions along the whole central axis, i.e., inlet subregion, intermediate subregion and outlet subregion, wherein the average loading of platinum group metal in one or two subregions, for example in the inlet subregion, or in the intermediate subregion, or in the outlet subregion, or in the inlet and intermediate subregions, or in the intermediate and outlet subregions, or in the inlet and outlet subregions, preferably in the inlet and outlet subregions is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the remaining subregion(s).

These three subregions as mentioned above for said regions accounting for 11.1 vol. %, 25 vol. %, 44.4 vol. %, 56.3 vol. %, 69.4 vol. % and 20 to 70 vol. % of the total volume of the particulate filter are regarded as three subregions and are not physically divided while they can have different average loading of platinum group metal. If the average loading of PGM in two subregions is higher than the average loading in the remaining subregion, the individual average loading of PGM in said two subregions can be the same or different. For example, the average loadings of PGM in three subregions are a, b and c, respectively and a>b>c (i.e., the individual average loadings of PGM in two subregions are different and higher than the average loading of PGM in the remaining subregion), then the above mentioned “times” can be calculated as (a+b)/2c.

In a preferred embodiment, the catalyst material layer, especially the catalyst material layer in said regions accounting for 11.1 vol. %, 25 vol. %, 44.4 vol. %, 56.3 vol. %, 69.4 vol. % and 20 to 70 vol. % of the total volume of the particulate filter comprises a first zone, a second zone, and a third zone;
the first zone begins at the inlet axial end and has a first length (L1) extending for 10-45% of the total filter length (L); the third zone begins at the outlet axial end and has a third length (L3) extending for 10-45% of the total filter length (L); the second zone begins at the axial end of first zone, ends at the axial beginning of the third zone; and
wherein the average loading of PGM in the first zone is higher than the average loading of PGM in the second zone, and the average loading of PGM in the third zone is higher than the average loading of PGM in the second zone, calculated as the weight of platinum group metal per zone volume.

In a preferred embodiment, the average loading of platinum group metal in the first and/or third zone is 1.5 to 15 times, for example 1.8, 2.0, 2.5, 3, 3.5, 4, 5, 6, 7, 8, 9, 10, 11, 12, 13 or 14 times, preferably 1.8 to 10 times, more preferably 2 to 7 times the average loading of platinum group metal in the second zone.

The average loading of PGM in said regions accounting for 11.1 vol. %, 25 vol. %, 44.4 vol. %, 56.3 vol. %, 69.4 vol. % and 20 to 70 vol. % of the total volume of the particulate filter can be in the range from 8 to 60 g/ft³, for example, 9 g/ft³, 10 g/ft³, 11 g/ft³, 12 g/ft³, 13 g/ft³, 14 g/ft³, 15 g/ft³, 18 g/ft³, 20 g/ft³, 25 g/ft³, 30 g/ft³, 32 g/ft³, 35 g/ft³, 40 g/ft³, 45 g/ft³, 50 g/ft³ or 55 g/ft³, preferably from 9 to 40 g/ft³, more preferably from 10 to 30 g/ft³ or from 10 to 25 g/ft³. The average loading of PGM in the remaining part of the particulate filter can be in the range from 2 to 30 g/ft³, for example 3 g/ft³, 4 g/ft³, 5 g/ft³, 6 g/ft³, 8 g/ft³, 10 g/ft³, 12 g/ft³, 14 g/ft³, 16 g/ft³, 18 g/ft³, 20 g/ft³, 22 g/ft³, 25 g/ft³, 28 g/ft³, preferably from 3 to 18 g/ft³, more preferably from 4 to 15 g/ft³ or from 4 to 12 g/ft³.

According to the present invention, the average loading of PGM of the particulate filter can be in the range from 2 to 50 g/ft³, for example 3 g/ft³, 4 g/ft³, 5 g/ft³, 6 g/ft³, 7 g/ft³, 8 g/ft³, 9 g/ft³, 10 g/ft³, 12 g/ft³, 15 g/ft³, 18 g/ft³, 20 g/ft³, 25 g/ft³, 30 g/ft³, 35 g/ft³, 40 g/ft³ or 45 g/ft³, preferably from 3 to 25 g/ft³, more preferably from 4 to 20 g/ft³ or from 4 to 15 g/ft³.

As mentioned above, the platinum group metal (PGM) can be selected from Ru, Rh, Os, Ir, Pd, Pt and Au. In a preferred embodiment, PGM is selected from Pt, Rh and Pd, preferably from Rh and Pd, more preferably a mixture of Rh and Pd. In a preferred embodiment, the catalyst material layer comprises a mixture of palladium and rhodium in a molar ratio of 1:10 to 10:1, preferably 1:5 to 5:1. In an embodiment, the catalyst material layer does not comprise Pt.

According to the present invention, the average loading of the catalyst material layer of the particulate filter can be in the range from 0.2 to 3 g/in³, for example 0.3 g/in³, 0.5 g/in³, 0.8 g/in³, 1.0 g/in³, 1.2 g/in³, 1.5 g/in³, 1.8 g/in³, 2 g/in³, 2.5 g/in³, or 3 g/in³, preferably from 0.3 to 2.5 g/in³ or from 0.5 to 2 g/in³, more preferably from 0.8 to 2 g/in³ or from 0.8 to 1.5 g/in³.

According to the present invention, the catalyst material layer further comprises at least one refractory metal oxide. The refractory metal oxide can be used as the support of the PGM. The details of the refractory metal oxide can refer to the above description for “Refractory metal oxide supports”. In an embodiment, refractory metal oxide is selected from the group consisting of alumina, zirconia, silica, titania, and combinations thereof.

In a preferred embodiment, the catalyst material layer can further comprise at least one oxygen storage component (OSC). The details of the refractory metal oxide can refer to the above description for “oxygen storage component”.

In a preferred embodiment, the catalyst material layer can further comprise at least one dopant. As used herein, the term “dopant” referring to a component that is intentionally added to enhance the activity of the catalyst material layer as compared to a catalyst material layer that does not have a dopant intentionally added. In the present disclosure, exemplary dopants are oxides of metals such as lanthanum, neodymium, praseodymium, yttrium, barium, cerium, niobium and combinations thereof.

The catalyst material layer may further comprise one or more of a selective catalytic reduction (SCR) catalyst, a diesel oxidation catalyst (DOC), an AMOx catalyst, a NOx trap, a NOx absorber catalyst, a hydrocarbon trap catalyst.

As used herein, the terms of “selective catalytic reduction” and “SCR” refer to the catalytic process of reducing oxides of nitrogen to nitrogen (N2) using a nitrogenous reductant. The SCR catalyst may include at least one material selected front: MOR; USY; ZSM-5; ZSM-20; betazeolite; CHA; LEV; AEI; AFX; FER; SAPO; ALPO; vanadium; vanadium oxide; titanium oxide; tungsten oxide; molybdenum oxide; cerium oxide; zirconium oxide; niobium oxide; iron; iron oxide; manganese oxide; copper; molybdenum; tungsten; and mixtures thereof. The support structures for the active components of the SCR catalyst may include any suitable zeolite, zeotype, or non-zeolitic compound. Alternatively, the SCR catalyst may include a metal, a metal oxide, or a mixed oxide as the active component. Transition metal loaded zeolites (e.g., copper-chabazite, or Cu-CHA, as well as copper-levyne, or Cu-LEV, as well as Fe-Beta) and zeotypes (e.g., copper-SAPO, or Cu-SAPO) are preferred.

As used herein, the terms of “diesel oxidation catalyst” and “DOC” refer to diesel oxidation catalysts, which are well-known in the art. Diesel oxidation catalysts are designed to oxidize CO to CO₂ and gas phase HC and an organic fraction of diesel particulates (soluble organic fraction) to CO₂ and H₂O. Typical diesel oxidation catalysts include platinum and optionally also palladium on a high surface area inorganic oxide support, such as alumina, silica-alumina, titania, silica-titania, and a zeolite. As used herein, the term includes a DEC (Diesel Exotherm Catalyst) with creates an exotherm.

As used herein, the terms of “ammonia oxidation catalyst” and “AMOx” refer to catalysts comprise at least a supported precious metal component, such as one or more platinum group metals (PGMs), which is effective to remove ammonia from an exhaust gas stream. In specific embodiments, the precious metal may include platinum, palladium, rhodium, ruthenium, iridium, silver or gold. In specific embodiments, the precious metal component includes physical mixtures or chemical or atomically-doped combinations of precious metals.

The precious metal component is typically deposited on a high surface area refractory met-al oxide support. Examples of suitable high surface area Refractory Metal Oxides include alumina, silica, titania, ceria, and zirconia, magnesia, barium oxide, manganese oxide, tungsten oxide, and rear earth metal oxide rear earth metal oxide, base metal oxides, as well as physical mixtures, chemical combinations and/or atomically-doped combinations there-of.

As used herein, the terms of “NOx adsorbed catalyst” and “NOx trap (also called Lean NOx trap, abbr. LNT)” refer to catalysts for reducing oxides of nitrogen (NO and NO₂) emissions from a lean burn internal combustion engine by means of adsorption. Typical NOx trap includes alkaline earth metal oxides, such as oxides of Mg, Ca, Sr and Ba, alkali metal oxides such as oxides of Li, Na, K, Rb and Cs, and rare earth metal oxides such as oxides of Ce, La, Pr and Nd in combination with precious metal catalysts such as platinum dispersed on an alumina support have been used in the purification of exhaust gas from an internal combustion engine. For NOx storage, baria is usually preferred because it forms nitrates at lean engine operation and releases the nitrates relatively easily under rich conditions.

As used herein, the term of “hydrocarbon trap” refers to catalysts for trapping hydrocarbons during cold operation periods and releasing them for oxidation during higher-temperature operating periods. The hydrocarbon trap may be provided by one or more hydrocarbon (HC) storage components for the adsorption of various hydrocarbons (HC). Typically, hydrocarbon storage material having minimum interactions of precious metals and the material can be used, e.g., a micro-porous material such as a zeolite or zeolite-like material. Preferably, the hydrocarbon storage material is a zeolite. Beta zeolite is particularly preferable since large pore opening of beta zeolite allows hydrocarbon molecules of diesel derived species to be trapped effectively. Other zeolites such as faujasite, chabazite, clinoptilolite, mordenite, silicalite, zeolite X, zeolite Y, ultrastable zeolite Y, ZSM-5 zeolite, offretite, can be used in addition to the beta zeolite to enhance HC storage in the cold start operation.

Another aspect of the present invention relates to a process for preparing the particulate filter according to the present invention, which comprises
i) providing a filter substrate;
ii) coating the filter substrate with a slurry containing at least one platinum group metal; and
iii) further coating the filter substrate obtained in step ii) with a solution or dispersion containing at least one platinum group metal.

The slurry in step ii) can be formed by mixing a liquid medium (such as water) with the platinum group metal (PGM) component and refractory metal oxide and if present OSC and dopant. In a preferred embodiment, the PGM component (e.g., in the form of a solution of a PGM salt) can be impregnated onto a refractory metal oxide support (e.g., as a powder) by, for example, incipient wetness techniques to obtain a wet powder. Water-soluble PGM compounds or salts or water-dispersible compounds or complexes of the PGM component may be used as long as the liquid medium used to impregnate or deposit the metal component onto the support particles does not adversely react with the metal or its compound or its complex or other components which may be present in the catalyst composition and is capable of being removed by volatilization or decomposition upon heating and/or application of a vacuum. Generally, both from the point of view of economics and environmental aspects, aqueous solutions of soluble compounds, salts, or complexes of the PGM component are advantageously utilized. In some embodiments, the PGM component are loaded onto the support by the co-impregnation method. The co-impregnation technique is known to those skilled in the art and is disclosed in, for example, U.S. Pat. No. 7,943,548, which is incorporated by reference herein for the relevant teachings. The wet powder can be mixed with the liquid medium such as water to form the slurry.

The slurry can be milled to enhance mixing of the particles and formation of a homogenous material. The milling can be accomplished in a ball mill, continuous mill, or other similar equipment, and the solids content of the slurry may be, e.g., about 20 to 60 wt. %, more particularly about 30 to 40 wt. %. In one embodiment, the post-milling slurry is characterized by a D90 particle size of about 1 to about 30 microns. The D90 is defined as the particle size at which 90% of the particles have a finer particle size.

After coating with the slurry, the filter substrate is generally calcined. An exemplary calcination process involves heat treatment in air at a temperature of about 400 to about 700° C. for about 10 minutes to about 3 hours. During the calcination step, the PGM component is converted into a catalytically active form of the metal or metal oxide thereof. The above process can be repeated as needed to reach the desired level of PGM.

In step iii) of the process according to the present invention, the filter substrate obtained in step ii) is coated with a solution or dispersion containing at least one platinum group metal. The solution or dispersion does not comprise the refractory metal oxide. Usually, the solution or the dispersion only comprises the PGM component and the liquid medium such as water.

Examples of PGM solution can include an amine-complex solution or solution of the nitrate of PGM (for example platinum nitrate, palladium nitrate, and rhodium nitrate).

Coating with the solution or dispersion containing at least one PGM would not substantially increase the average loading (the thickness) of the catalyst material layer because the solution or dispersion does not comprise refractory metal oxide.

Coating with the solution or dispersion containing at least one PGM is carried out within the central region of the filter substrate, for example within a central region which is around the whole central axis of the particulate filter substrate and accounts for 20 to 70 vol. % of the total volume of the particulate filter substrate, preferably 22 to 70 vol. %, more preferably 25 to 70 vol. %, or 30 to 70 vol. %, for example 35 vol. %, 40 vol. %, 45 vol. %, 50 vol. %, 55 vol. %, 60 vol. %, 65 vol. %, 68 vol. % or 69 vol. % of the total volume of the particulate filter substrate.

In a specific embodiment, coating with PGM solution or dispersion can be carried out as following: PGM solution or dispersion is divided into two portions. The first portion of the solution or dispersion is applied to the filter substrate from one side to extend 25 to 75%, preferably 40 to 60% of the axial length of the filter substrate and then the filter substrate the dried. The second portion of the solution or dispersion is applied to the filter substrate from another side to extend the remaining axial length of the filter substrate and then the filter substrate is dried again. A person skilled in the art can understand that the weight of each portion is in proportion to the axial length to be coated.

In a preferred embodiment, the PGM solution or dispersion is only applied to extend (cover) part of the total axial length of the particulate filter substrate, for example from 10 to 90% of the total axial length, for example 20%, 30%, 40%, 50%, 60%, 70% or 80%, preferably from 20 to 80% or from 30 to 70% of the total axial length. In a preferred embodiment, the PGM solution or dispersion is applied to extend said axial length percentage from inlet side or from outlet side. In a more preferred embodiment, the PGM solution or dispersion is applied to extend said axial length percentage from both inlet and outlet side. The ratio of the axial length of inlet side to the axial length of outlet side covered by the PGM solution or dispersion can be in the range from 1:5 to 5:1, for example 1:4, 1:3, 1:2, 1:1, 2:1, 3:1 or 4:1, preferably from 1:3 to 3:1.

After coating with the solution or dispersion containing at least one PGM, the filter substrate is generally calcined. An exemplary calcination process involves heat treatment in air at a temperature of about 400 to about 700° C. for about 10 minutes to about 3 hours. During the calcination step, the PGM component is converted into a catalytically active form of the metal or metal oxide thereof. The above process can be repeated as needed to reach the desired level of PGM.

In a preferred embodiment, the amount of platinum group metal applied in step iii) is 50 to 120% by weight of the amount of platinum group metal applied in step ii), for example 60%, 70%, 80%, 90%, 100% or 110% by weight of the amount of platinum group metal applied in step ii), preferably 60 to 100% or 60 to 95% by weight of the amount of platinum group metal applied in step ii).

A further aspect of the present invention relates to a method for the treatment of exhaust gas from an internal combustion engine, which comprises flowing the exhaust gas from the engine through the particulate filter according to the present invention or prepared by the process according to the present invention. The exhaust gas comprises unburned hydrocarbons, carbon monoxide, nitrogen oxides, and particulate matter.

### EXAMPLES

The present invention is further illustrated by the following examples, which are set forth to illustrate the present invention and is not to be construed as limiting thereof. Unless otherwise noted, all parts and percentages are by weight, and all weight percentages are expressed on a dry basis, meaning excluding water content, unless otherwise indicated. In each of the examples, the filter substrate was made of cordierite.

### Example 1—Comparative

The particulate filter prepared in example 1 has a Pd/Rh catalytic layer with a PGM loading of 11 g/ft³ (Pd/Rh=3/8). The particulate filter of example 1 was prepared by using a single coat from inlet side of a wall-flow filter substrate. The wall-flow filter substrate had a size of 132 mm (D)*127 mm (L), a volume of 1.74 L, a cell density of 300 cells per square inch, a wall thickness of approximately 200 μm, a porosity of 63% and a mean pore size of 17 μm in diameter by mercury intrusion measurements.

The Pd/Rh catalytic layer coated onto the substrate contains a prior art three-way conversion (TWC) catalyst composite. The catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above powders into water, followed by the addition of barium hydroxide and zirconium nitrate solution. The slurry was then milled to a particle size of 90% being 5 μm. The slurry was then coated from the inlet side of the wall-flow filter substrate and covering the total substrate length. After coating, the filter substrate plus the inlet coat were dried at 150° C. and then calcined at a temperature of 550° C. for about 1 hour. The calcined Pd/Rh catalytic layer was having 68.7 wt. % ceria-zirconia composite, 0.14 wt. % palladium, 0.37 wt. % rhodium, 4.6 wt. % of barium oxide, 1.4 w. % zirconia oxide with the balance being alumina. The total loading of the catalyst material layer was 1.24 g/in³.

### Example 2

The particulate filter prepared in example 2 has a first Pd/Rh catalytic layer with a PGM loading of 6 g/ft³ (Pd/Rh=1/1), coated onto the substrate from inlet side and covering the total substrate area and length; and a second Rh catalytic component with a local Rh loading of 15.5 g/ft³, coated onto the substrate from both inlet side and outlet side and covering radial center area with a smaller diameter (D=75 mm) and the total substrate length.

The wall-flow filter substrate had a size of 132 mm (D)*127 mm (L), a volume of 1.74 L, a cell density of 300 cells per square inch, a wall thickness of approximately 200 μm, a porosity of 63% and a mean pore size of 17 μm in diameter by mercury intrusion measurements.

The first Pd/Rh catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above powders into water, followed by addition of barium hydroxide and zirconium nitrate solution. The slurry was then milled to a particle size of 90% being 5 μm. The slurry was then coated from the inlet side of the wall-flow filter substrate and covering the total substrate length using deposition methods known in the art. After coating, the filter substrate plus the inlet coat were dried at 150° C. and then calcined at a temperature of 550° C. for about 1 hour. The calcined Pd/Rh catalytic layer had 68.8 wt. % ceria-zirconia composite, 0.14 wt. % palladium, 0.14 wt. % rhodium, 4.6 wt. % of barium oxide and 1.4 wt. % zirconia oxide with the balance being alumina. The total loading of the catalyst material layer was 1.23 g/in³.

The second Rh catalytic component was prepared as following:

In total, 5 g/ft³ rhodium (averaged of the total volume of the particulate filter), in the form of a rhodium nitrate solution, was deposited such that it covers a radial center area with a diameter (D=75 mm) smaller than that of the substrate. A solution injection pipe with identical inner diameter (D=75 mm) was used to achieve this radial distribution. The rhodium solution was evenly divided into two halves and the first half of the rhodium solution was diluted and then conducted through the pipe and coated onto the outlet side of the filter. The part was then dried at 150° C. before applying the second half of the rhodium solution from the inlet side. Dilution of the rhodium solution was carried out in such way that each solution coat will extend to 50 to 55% of the substrate length. After solution coating from both sides, the filter was dried at 150° C. and then calcined at a temperature of 550° C. for about 1 hour in air.

### Example 3

The particulate filter of example 3 was prepared in the similar way as Example 2, except that the second Rh catalytic component was deposited to cover a radial center area with a diameter of D=95 mm and the total substrate length. This resulted in a local Rh loading of 9.7 g/ft³ from the second Rh catalytic component.

### Example 4

The particulate filter of example 4 was prepared in the similar way as Example 2, except that the second Rh catalytic component was deposited to cover a radial center area with a diameter of D=109 mm and the total substrate length. This resulted in a local Rh loading of 7.3 g/ft³ from the second Rh catalytic component.

### Example 5

The particulate filter of example 5 was prepared in the similar way as Example 2, except that the second Rh catalytic component was deposited to cover a radial center area with a diameter of D=75 mm and 33% of total substrate length from both inlet and outlet side. This resulted in a local Rh loading of 23.3 g/ft³ from the second Rh catalytic component.

### Example 6—Comparative

The particulate filter of example 6 was prepared in the similar way as Example 2, except that the second Rh catalytic component was deposited to cover the whole substrate area (D=132 mm) and the total substrate length. This resulted in a homogeneous Rh loading of 5 g/ft³ from the second Rh catalytic component.

### Example 7—Comparative

The particulate filter of example 7 has a first Pd/Rh catalytic layer with a PGM loading of 6 g/ft³ (Pd/Rh=1/1), coated onto the substrate from inlet side and covering the total substrate area and length; and a second Rh catalytic layer with a local Rh loading of 15.5 g/ft³, coated onto the substrate from both inlet side and outlet side and covering radial center area with a smaller diameter (0=75 mm) and the total substrate length.

The wall-flow filter substrate had a size of 132 mm (D)*127 mm (L), a volume of 1.74 L, a cell density of 300 cells per square inch, a wall thickness of approximately 200 μm, a porosity of 63% and a mean pore size of 17 μm in diameter by mercury intrusion measurements.

The first Pd/Rh catalytic layer was prepared as following:

Palladium in the form of a palladium nitrate solution was impregnated by planetary mixer onto a refractory alumina and a stabilized ceria-zirconia composite with approximately 40 wt. % ceria to form a wet powder while achieving incipient wetness. Rhodium in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above powders into water, followed by addition of barium hydroxide and zirconium nitrate solution. The slurry was then milled to a particle size of 90% being 5 μm. The slurry was then coated from the inlet side of the wall-flow filter substrate and covering the total substrate length using deposition methods known in the art. After coating, the filter substrate plus the inlet coat were dried at 150° C. and then calcined at a temperature of 550° C. for about 1 hour. The calcined Pd/Rh catalytic layer was having 68.8 wt. % ceria-zirconia composite, 0.18 wt. % palladium, 0.18 wt. % rhodium, 4.6 wt. % of barium oxide and 1.4 wt. % zirconia oxide with the balance being alumina. The total loading of the catalyst material layer was 0.99 g/in³.

The second Rh catalytic layer was prepared as following:

In total, 5 g/ft³ rhodium (averaged of the total volume of the particulate filter) in the form of a rhodium nitrate solution was impregnated by planetary mixer onto a refractory alumina and a stabilized ceria-zirconia composite with approximately 40 wt. % ceria to form a wet powder while achieving incipient wetness. An aqueous slurry was formed by adding the above powders into water, followed by addition of barium hydroxide and zirconium nitrate solution. The slurry was then milled to a particle size of 90% being 5 μm. The slurry was then coated from both the inlet and the outlet side of the filter and covering a radial center area with a smaller diameter (D=75 mm) and 50% of the total substrate length from each side. After coating, the filter was dried at 150° C. and then calcined at a temperature of 550° C. for about 1 hour. The calcined second Rh catalytic layer had 68.2 wt. % ceria-zirconia composite, 1.17 wt. % rhodium, 4.6 wt. % of barium oxide and 1.4 wt. % zirconia oxide with the balance being alumina. The local loading of the catalytic layer was 0.77 g/in³.

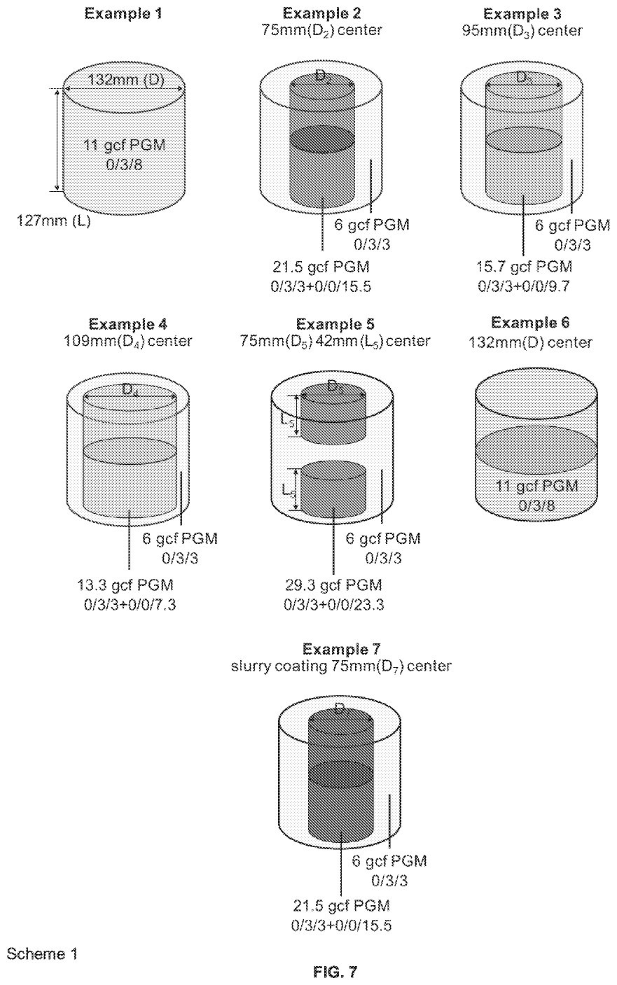

The total loading of catalyst material layer and total loading of precious metal of the particulate filter in Examples 1 to 7 are identical, despite of different PGM distribution layouts, which is illustrated in Scheme 1 of FIG. 7.

### Example 8—Testing of Catalytic Particulate Filter of Example 1 to 4

### 8.1 As CCC

### 8.1.1 Under WLTC

The particulate filers in Examples 1 to 4 were aged under an exothermic ageing protocol using an engine setup to operate such that the typical inlet temperature is ˜875° C. and the typical catalyst bed temperature is ˜925° C. and does not exceed ˜980° C. The engine-out gas feed composition alternates between rich and lean to simulate typical operating conditions for a vehicle durability test. All catalytic filters were aged using the same conditions for 100 hours.

The emission performance was tested using a 2.0 L turbo-charged engine with a close-coupled catalyst (CCC)-only emission control system configuration operating under the WLTC test protocol. Each catalytic particulate filter was installed at close-coupled position as CCC, tested at least three times to assure high experiment repeatability and data consistence.

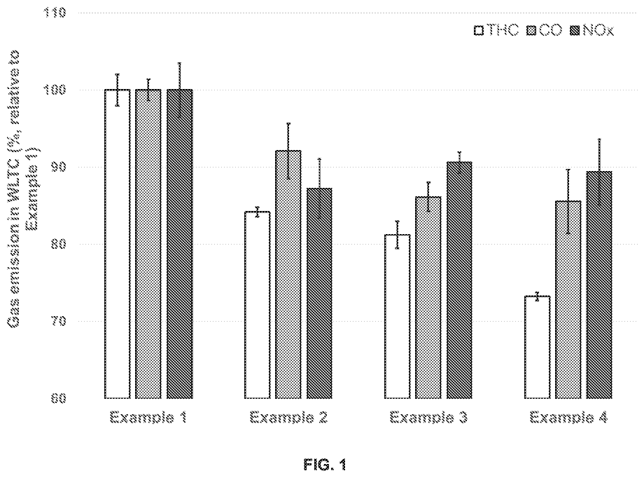

As shown in FIG. 1, radial enrichment of platinum group metal, in this case rhodium, using the solution coating approach, promoted the catalytic activity of the catalytic particulate filter. The particulate filters of inventive examples 2 to 4, showed up to ˜25% THC, ˜15% CO and ˜10% NOx improvement in the WLTC test compared to the particulate filter of comparative Example 1 at the same platinum group metal loading without a change in the washcoat support formulation.

### 8.1.2 Under WLTC Phase 1

The particulate filers of Examples 1 to 4 as CCC were also tested under WLTC phase 1. WLTC phase 1 represents cold start and low speed driving modes (urban).

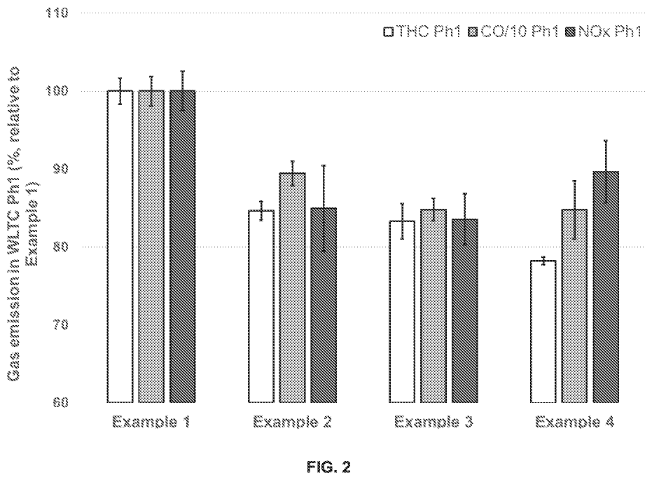

As shown in FIG. 2, the particulate filters of inventive examples 2 to 4, showed up to ˜20% THC, ˜15% CO and ˜15% NOx improvement in the test of WLTC phase 1 compared to the particulate filter of comparative Example 1.

### 8.2 As UFC

### 8.2.1 Under WLTC

In addition, the emission performance of the examples filter was further evaluated using the same 2.0 L turbo-charged engine but with a different close-coupled catalyst (CCC)+underfloor catalyst (UFC) emission control system configuration. An TWC part, 132.1 mm (D) by 50.8 mm (L), 66 gcf PGM, oven aged 1200° C. 20 hr, was used as CCC and the example filters were installed at UF position as UFC. The distance between CCC and UFC was 800 mm. Each catalytic system was tested at least three times to assure high experiment repeatability and data consistence.

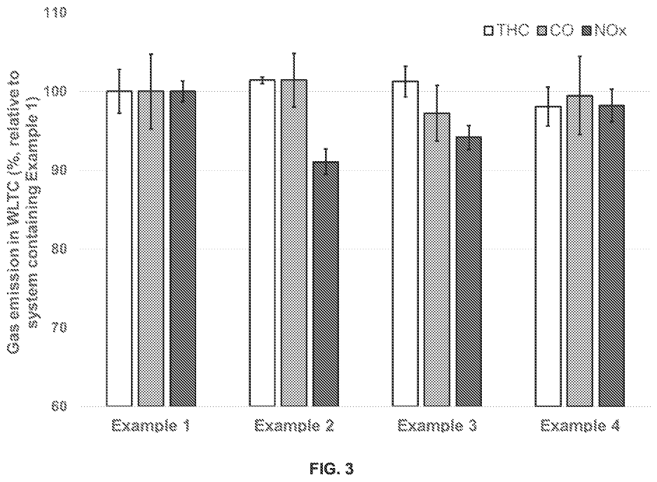

As shown in FIG. 3, in this CCC+ UFC system, the best performer, inventive Examples 2 and 3, remained to exhibit up to ˜10% NOx improvement compared to reference system with the filter of Example 1.

### Example 9—Testing of Catalytic Particulate Filter of Examples 1, 2, 5 and 6

### 9.1 Under WLTC

Under a different ageing set-up, the particulate filter of Examples 1, 2, 5, 6 were aged under an exothermic ageing protocol using an engine setup to operate such that the typical inlet temperature is ˜800° C. and the typical catalyst bed temperature is ˜850° C. and does not exceed ˜900° C. The engine-out gas feed composition alternates between rich and lean to simulate typical operating conditions for a vehicle durability test. All catalytic filters were aged using the same conditions for 125 hours.

The emission performance was tested using a 2.0 L turbo-charged engine with a close-coupled catalyst (CCC)-only emission control system configuration operating under the WLTC test protocol. Each catalytic particulate filter was installed at close-coupled position as CCC, tested at least three times to assure high experiment repeatability and data consistence.

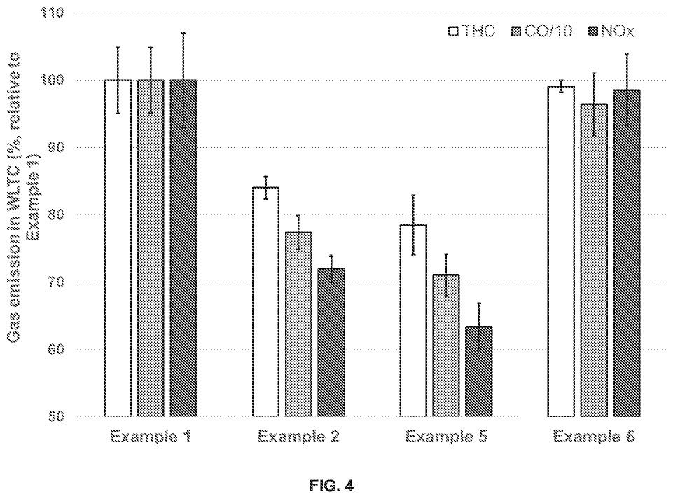

As demonstrated in FIG. 4, the particulate filter of Examples 2 & 5 showed superior THC, CO and NOx conversion activity compared to the particulate filter in comparative Example 1, proving the robustness of PGM radial enrichment under different ageing protocols. This is attributed to carefully designed rhodium enrichment zone, by PGM solution coating in the radial center area. Due to the special designed rhodium distribution in the axial direction, the activity of particulate filter of Example 5 is further improved compare to the activity of particulate filter of Example 2. On the other hand, the particulate filter of Example 6, despite of similar PGM solution coating approach used, failed to show advantage in pollutant conversion activity. This proves that PGM solution coating alone, without radial enrichment, does not benefit the three-way conversion activity.

### 9.2 Under WLTC Phase 1

The particulate filers of Examples 1 to 4 as CCC were also tested under WLTC phase 1. WLTC phase 1 represents cold start and low speed driving modes (urban).

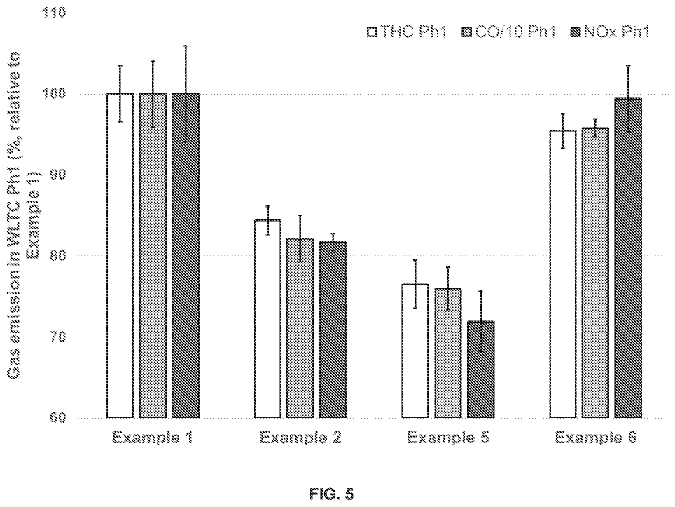

As demonstrated in FIG. 5, the particulate filter of Examples 2 & 5 showed superior THC, CO and NOx conversion activity compared to the particulate filter in comparative Example 1. Due to the special designed rhodium distribution in the axial direction, the activity of particulate filter of Example 5 is further improved compare to the activity of particulate filter of Example 2. On the other hand, the particulate filter of Example 6, despite of similar PGM solution coating approach used, failed to show advantage in pollutant conversion activity.

### Example 10—Backpressure Comparison

For catalytic filter, backpressure (also known as pressure drop) is also an important parameter that needs to be carefully watched. PGM solution coating, disclosed in this invention, does not affect the backpressure of the catalytic filter, while slurry coating can result in unfavorably higher backpressure of the final catalytic filter.

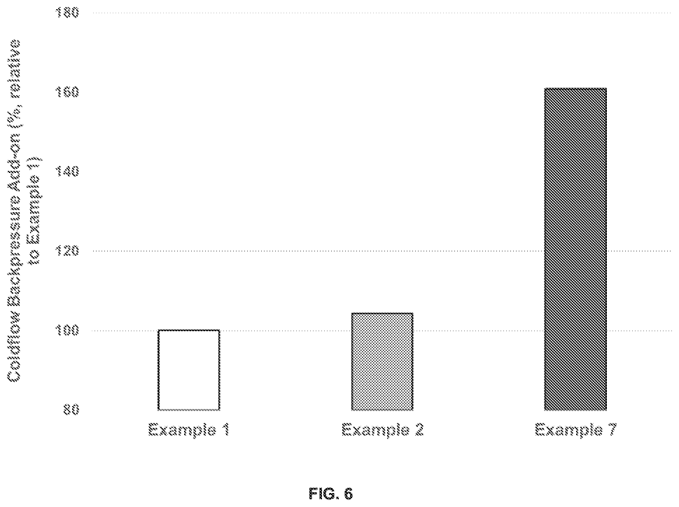

As shown in FIG. 6, the particulate filter of Example 2, with Rh enriched in the radial center using the PGM solution coating approach, showed negligible backpressure difference compared to Example 1. While the particulate filter of Example 7, with Rh similarly enriched in the radial center using the known slurry coating approach, showed significantly higher backpressure add-on compared to comparative Example 1 and inventive Example 2.

Here, backpressure add-on was calculated in the following way:

$$Backpressure add - on = {Backpressure}_{catalyzed filter} - {Backpressure}_{substrate}$$

All backpressure values were measured on Superflow at 600 m³/h flow rate and 25° C.

1. A particulate filter for the treatment of exhaust gas from an internal combustion engine, wherein the particulate filter comprises a catalyst material layer comprising at least one platinum group metal, and the average loading of platinum group metal in the region which is around the whole central axis of the particulate filter and accounts for 20 to 70 vol. % of the total volume of the particulate filter, is 1.1 to 10 times the average loading of platinum group metal in the remaining part of the particulate filter.

2. The particulate filter according to claim 1, wherein the average loading of platinum group metal in said region around the whole central axis and accounting for 20 to 70 vol. % of the total volume of the particulate filter, is 1.2 to 8 times the average loading of platinum group metal in the remaining part of the particulate filter.

3. The particulate filter according to claim 1, wherein the difference in the average loading of the catalyst material layer between said region around the whole central axis and accounting for 20 to 70 vol. % of the total volume of the particulate filter and the remaining part of the particulate filter is no more than 25% based on the lower average loading of the catalyst material layer.

4. The particulate filter according to claim 1, wherein said region around the whole central axis and accounting for 20 to 70 vol. % of the total volume of the particulate filter is evenly divided into three subregions along the whole central axis, wherein the average loading of platinum group metal in one or two subregions is 1.5 to 15 times the average loading of platinum group metal in the remaining subregion(s).

5. The particulate filter according to claim 1, wherein the particulate filter comprises a catalyst material layer comprising at least one platinum group metal, and the amount of the platinum group metal in the region which is around the whole central axis of the particulate filter and accounts for 11.1 vol. % of the total volume of the particulate filter, is in the range from 12 to 35 wt. %, based on the total weight of the platinum group metal in the particulate filter, and
wherein the difference in the average loading of the catalyst material layer between said region accounting for 11.1 vol. % of the total volume of the particulate filter and the remaining part of the particulate filter is no more than 25%, based on the lower average loading of the catalyst material layer.

6. The particulate filter according to claim 5, wherein the amount of the platinum group metal in the region which is around the whole central axis of the particulate filter and accounts for 11.1 vol. % of the total volume of the particulate filter, is in the range from 12.5 to 30 wt. % based on the total weight of the platinum group metal in the particulate filter.

7. The particulate filter according to claim 5, wherein the difference in the average loading of the catalyst material layer between said region accounting for 11.1 vol. % of the total volume of the particulate filter and the remaining part of the particulate filter is no more than 15%, based on the lower average loading of the catalyst material layer.

8. The particulate filter according to claim 1, wherein the amount of the platinum group metal in the region which is around the whole central axis of the particulate filter and accounts for 25 vol. % of the total volume of the particulate filter, is in the range from 27 to 60 wt. % based on the total weight of the platinum group metal in the particulate filter, and
wherein the difference in the average loading of the catalyst material layer between said region accounting for 25 vol. % of the total volume of the particulate filter and the remaining part of the particulate filter is no more than 25% based on the lower average loading of the catalyst material layer.

9. The particulate filter according to claim 1, wherein the amount of the platinum group metal in the region which is around the whole central axis of the particulate filter and accounts for 32.3 vol. % of the total volume of the particulate filter, is in the range from 34 to 80 wt. % based on the total weight of the platinum group metal in the particulate filter, and
wherein the difference in the average loading of the catalyst material layer between said region accounting for 32.3 vol. % of the total volume of the particulate filter and the remaining part of the particulate filter is no more than 25% based on the lower average loading of the catalyst material layer.

10. The particulate filter according to claim 1, wherein the amount of the platinum group metal in the region which is around the whole central axis of the particulate filter and accounts for 44.4 vol. % of the total volume of the particulate filter, is in the range from 47 to 85 wt. %, based on the total weight of the platinum group metal in the particulate filter, and
wherein the difference in the average loading of the catalyst material layer between said region accounting for 44.4 vol. % of the total volume of the particulate filter and the remaining part of the particulate filter is no more than 25% based on the lower average loading of the catalyst material layer.

11. The particulate filter according to claim 5, wherein said region accounting for 11.1 vol. % of the total volume of the particulate filter is evenly divided into three subregions along the whole central axis, wherein the average loading of platinum group metal in one or two subregions is 1.5 to 15 times, the average loading of platinum group metal in the remaining subregion(s).

12. The particulate filter according to claim 9, wherein said region accounting for 32.3 vol. % of the total volume of the particulate filter is evenly divided into three subregions along the whole central axis, and wherein the average loading of platinum group metal in one or two subregions, is 1.5 to 15 times the average loading of platinum group metal in the remaining subregion(s).

13. The particulate filter according to claim 1, wherein the average loading of the platinum group metal of the particulate filter is in the range from 2 to 50 g/ft³.

14. The particulate filter according to claim 1, wherein the average loading of the catalyst material layer of the particulate filter is in the range from 0.2 to 3 g/in³.

15. The particulate filter according to claim 1, wherein the catalyst material layer further comprises at least one refractory metal oxide.

16. A process for preparing the particulate filter according to claim 1, which comprises
i) providing a filter substrate;
ii) coating the filter substrate with a slurry containing at least one platinum group metal; and
iii) further coating the filter substrate obtained in step ii) with a solution or dispersion containing at least one platinum group metal.

17. The process according to claim 16, wherein the slurry comprises at least one refractory metal oxide.

18. The process according to claim 16, wherein the amount of platinum group metal applied in step iii) is 50 to 120% by weight of the amount of platinum group metal applied in step ii).

19. The process according to claim 16, wherein step ii) and step iii) further comprise calcinating the coated filter substrate after coating.

20. A method for the treatment of exhaust gas from an internal combustion engine, which comprises flowing the exhaust gas from the engine through the particulate filter according to claim 1.

21. The method according to claim 20, wherein the exhaust gas comprises unburned hydrocarbons, carbon monoxide, nitrogen oxides, and particulate matter.
